(19) United States
(12) Patent Application Publication
(10) Pub. No.: US 2025/0350001 A1
(43) Pub. Date: Nov. 13, 2025

(54) POWER STORAGE DEVICE

(71) Applicant: TOYOTA JIDOSHA KABUSHIKI KAISHA, Toyota-shi (JP)

(72) Inventors: Akio UOTANI, Nagoya-shi (JP); Dexu ZHANG, Mishima-shi (JP); Yoshinobu KUROYAMA, Aichi-gun (JP); Daisuke KAMESAKI, Okazaki-shi (JP); Seigo FUJISHIMA, Miyoshi-shi (JP); Yuki TAKAHASHI, Miyoshi-shi (JP)

(73) Assignee: TOYOTA JIDOSHA KABUSHIKI KAISHA, Toyota-shi (JP)

(21) Appl. No.: 19/045,865

(22) Filed: Feb. 5, 2025

(30) Foreign Application Priority Data
May 10, 2024 (JP) 2024-076961

(51) Int. Cl. H01M 50/578; H01M 50/204; H01M 50/249; H01M 50/289; H01M 50/367; H01M 50/586

(52) U.S. Cl. CPC H01M 50/578; H01M 50/204; H01M 50/249; H01M 50/289; H01M 50/367; H01M 50/586; H01M 2200/20

(57) ABSTRACT

The power storage device includes a first power storage stack and a second power storage stack, a housing case that houses the first power storage stack and the second power storage stack, and an electrical connection member that electrically connects the first power storage stack and the second power storage stack, wherein the housing case includes an expansible region that is inflatable and deformable when gas is discharged from the first power storage stack or the second power storage stack, and the electrical connection member has a fragile portion and is fixed to the expansible region.

### CROSS-REFERENCE TO RELATED APPLICATION

This application claims priority to Japanese Patent Application No. 2024-076961 filed on May 10, 2024, incorporated herein by reference in its entirety.

### BACKGROUND

### 1. Technical Field

The present disclosure relates to a power storage device mounted on a vehicle.

### 2. Description of Related Art

As a related-art power storage device, WO2020/134054 discloses a structure in which a partition member for partitioning a region in which a plurality of power storage stacks is disposed is made of a hollow member and a hollow portion of the hollow member is used as an exhaust path. The hollow member has a plurality of through holes for introducing gas discharged from the power storage stack. The gas introduced into the hollow portion from the through holes is discharged to the outside of a housing case through an exhaust path provided in a wall portion of the housing case.

### SUMMARY

In general, the power storage stacks are electrically connected in series, and a power storage module constituted by the power storage stacks includes a total positive terminal and a total negative terminal of a total potential in the power storage module.

When the gas is discharged from any one of the power storage stacks, the gas may spread in a housing space in the housing case. The gas includes debris such as metal foreign matter, and the total positive terminal and the total negative terminal may be electrically connected by the debris. In such a case, there is a concern that the total positive terminal and the total negative terminal are short-circuited and the power storage stacks constituting the power storage module generate heat as a whole.

The present disclosure has been made in view of the above problem, and an object of the present disclosure is to provide a power storage device capable of suppressing heat generation of a plurality of power storage stacks as a whole.

A power storage device according to the present disclosure includes:
a first power storage stack and a second power storage stack;
a housing case that houses the first power storage stack and the second power storage stack; and
an electrical connection member that electrically connects the first power storage stack and the second power storage stack.

The housing case includes an expansible region that is expansively deformable when gas is discharged from the first power storage stack or the second power storage stack.

The electrical connection member includes a fragile portion that is breakable, and is fixed to the expansible region.

With the above configuration, when the gas is discharged from the first power storage stack or the second power storage stack, the expansible region of the housing case expands. Therefore, the fragile portion of the electrical connection member can be broken. Thus, the electrical connection between the first power storage stack and the second power storage stack can be interrupted. As a result, it is possible to suppress heat generation of the first power storage stack and the second power storage stack as a whole.

In the power storage device according to the present disclosure, an insulating member may be interposed between the electrical connection member and the expansible region.

With the above configuration, the electrical connection member and the expansible region of the housing case can be electrically insulated from each other.

The power storage device according to the present disclosure may further include a cross member that is disposed between the first power storage stack and the second power storage stack in the housing case and extends along a direction intersecting an arrangement direction in which the first power storage stack and the second power storage stack are arranged.

In this case, the expansible region may be disposed to face the cross member in a direction intersecting the arrangement direction, and
the electrical connection member may be provided to straddle the cross member.

With the above configuration, the moving direction of the gas is changed by the cross member, and the gas easily moves toward the expansible region. Thus, the expansible region is easily deformed by the pressure from the gas, and the fragile portion is easily broken when the gas is generated. Since the electrical connection member is provided to straddle the cross member, interference between the electrical connection member and the cross member can be avoided. It is also possible to break the fragile portion by utilizing the force of the gas whose movement has been changed.

In the power storage device according to the present disclosure, the housing case includes a top plate portion.

The expansible region may be provided to the top plate portion.

With the above configuration, the electrical connection member can be broken by the expansion of the top plate.

According to the present disclosure, it is possible to provide the power storage device capable of suppressing heat generation of the power storage stacks as a whole.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a vehicle equipped with a power storage device according to a first embodiment;

FIG. 2 is a diagram illustrating a state in which the power storage device according to the first embodiment is fixed to a vehicle body;

FIG. 3 is a plan view illustrating an internal configuration of the power storage device according to Embodiment 1;

FIG. 4 is a schematic cross-sectional view of the power storage device along IV-IV shown in FIG. 3;

FIG. 5 is a schematic cross-sectional view illustrating a state in which gases are discharged from a first power storage stack in the power storage device according to Embodiment 1; and

FIG. 6 is a plan view illustrating an internal configuration of a power storage device according to Embodiment 2.

### DETAILED DESCRIPTION OF EMBODIMENTS

Hereinafter, embodiments of the present disclosure will be described in detail with reference to the drawings. In the following embodiments, the same or common parts are denoted by the same reference numerals in the drawings, and the description thereof will not be repeated.

### First Embodiment

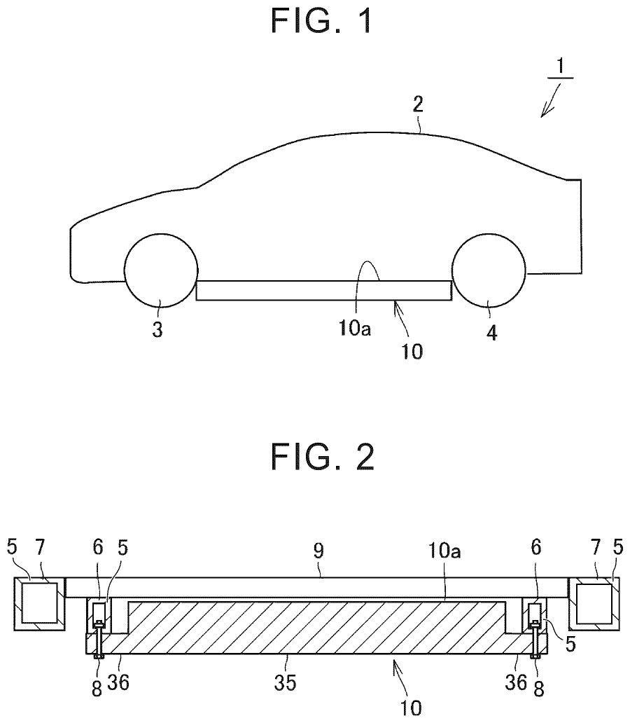

FIG. 1 is a schematic diagram illustrating a vehicle according to a first embodiment. FIG. 2 is a diagram illustrating a state in which the power storage device according to the first embodiment is fixed to a vehicle body. Referring to FIGS. 1 and 2, a vehicle 1 according to an embodiment will be described.

The vehicle 1 is a hybrid electric vehicle that can travel by using power of at least one of a motor and an engine, or an electrified vehicle that travels by a driving force obtained by electric energy.

The vehicle 1 includes a vehicle body 2, a front wheel 3, a rear wheel 4, and a power storage device 10. The vehicle body 2 includes a frame member 5. The power storage device 10 is disposed below the vehicle body 2. The power storage device 10 is disposed, for example, between the front wheel 3 and the rear wheel 4. Note that a part of the power storage device 10 may be disposed so as to overlap at least one of the front wheel 3 and the rear wheel 4 when viewed from the width direction of the vehicle 1. The power storage device 10 has an upper surface 10a. The upper surface 10a may function as a floor member defining the interior of the vehicle.

The frame member 5 includes a pair of side members 6 and a pair of side sills 7. The pair of side sills 7 are disposed on both end sides in the width direction of the vehicle 1. The pair of side members 6 are disposed inside the pair of side sills 7 at a distance. The pair of side members 6 and the pair of side sills 7 extend along the front-rear direction of the vehicle 1.

The pair of side members 6 are spaced apart in the width direction of the vehicle 1. A main body portion 35 of the power storage device 10 is disposed in a gap between the pair of side members 6. A gap is provided between the main body portion 35 and the pair of side members 6. Thus, even when the vehicle 1 collides laterally, it is possible to prevent an impact from being input to the power storage device 10.

The fixed portions 36 are provided on both side surfaces of the main body portion 35 in the width direction of the vehicle 1. The fixed portion 36 is fixed to the pair of side members 6 by the fastening member 8.

The frame member 5 also includes a cross frame member 9. The cross frame member 9 is provided so as to straddle the other side sill 7 from the one side sill 7 above the power storage device 10. An upper surface 10a of the power storage device 10 is fixed to the cross frame member 9.

In the above description, a case in which the frame member 5 includes the pair of side members 6 and the pair of side sills 7 has been described as an example, but the present disclosure is not limited thereto. The pair of side sills 7 may also have the function of the pair of side members 6. In this case, the pair of side members 6 may be omitted, and the fixed portion 36 may be fixed to the pair of side sills 7.

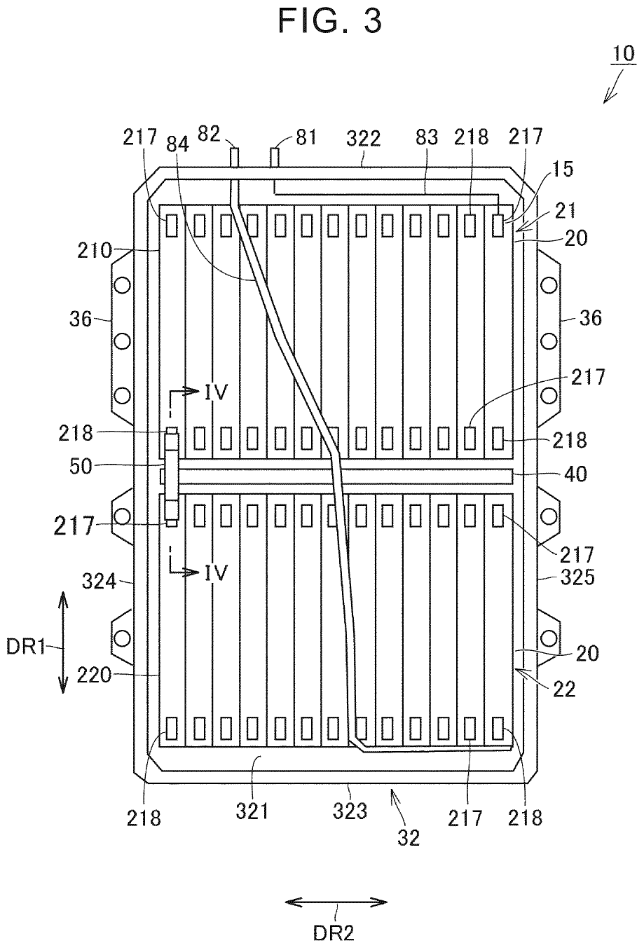

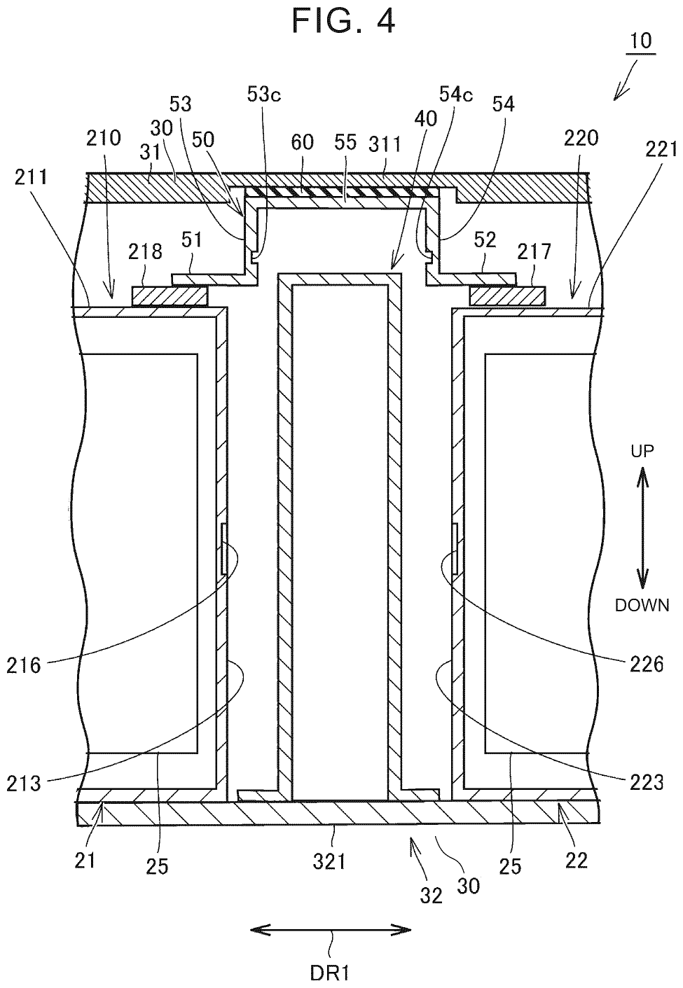

FIG. 3 is a plan view illustrating an internal configuration of the power storage device according to Embodiment 1. FIG. 4 is a schematic cross-sectional view of the power storage device along IV-IV shown in FIG. 3. The power storage device 10 according to the first embodiment will be described with reference to FIGS. 3 and 4.

As illustrated in FIGS. 3 and 4, the power storage device 10 includes a power storage module 20, a housing case 30, a cross member 40, an electrical connection member 50, an insulating member 60, a first connector 81, a second connector 82, and wires 83 and 84.

The power storage module 20 includes a plurality of power storage stacks. In the present embodiment, the plurality of power storage stacks includes a first power storage stack 21 and a second power storage stack 22.

The first power storage stack 21 and the second power storage stack 22 are arranged at intervals in the first direction (DR1 direction). The first direction is, for example, parallel to the front-rear direction of the vehicle 1 in a mounted state in which the power storage device 10 is mounted on the vehicle 1.

The first power storage stack 21 includes a plurality of first unit cells 210. The plurality of first unit cells 210 are arranged in a second direction (DR2 direction) perpendicular to the first direction. The second direction is, for example, parallel to the left-right direction of the vehicle 1 in the above-described mounted state.

The first unit cell 210 is provided with a first exhaust valve 216. The first exhaust valve 216 is provided in a housing 211, which will be described later. The first exhaust valve 216 is a valve for discharging gas from the inside of the first unit cell 210 when the pressure in the first unit cell 210 becomes higher than a predetermined pressure. The housing 211 has a pair of side wall portions facing each other in the longitudinal direction, which will be described later. The first exhaust valve 216 is provided on one of the side wall portions 213 of the pair of side wall portions. For example, the side wall portion 213 is located on the side where the second power storage stack 22 is located in the first direction.

The plurality of first unit cells 210 may be arranged such that the first exhaust valves 216 provided in the side wall portions 213 located on the side where the second power storage stack 22 is located are continuously arranged in the second direction. The plurality of first unit cells 210 may be arranged in the second direction such that the first exhaust valves 216 are alternately positioned on one side in the first direction and the other side in the first direction.

The second power storage stack 22 includes a plurality of second unit cells 220. The plurality of second unit cells 220 are arranged in the second direction.

The second unit cell 220 is provided with a second exhaust valve 226. The second exhaust valve 226 is provided in a housing 221, which will be described later. The second exhaust valve 226 is a valve for discharging gas from the inside of the second unit cell 220 when the pressure in the second unit cell 220 becomes higher than a predetermined pressure. The housing 221 has a pair of side wall portions facing each other in the longitudinal direction, which will be described later. The second exhaust valve 226 is provided on one of the side wall portions 223 of the pair of side wall portions. For example, the side wall portion 223 is located on the side where the first power storage stack 21 is located in the first direction.

The plurality of second unit cells 220 may be arranged such that the second exhaust valves 226 provided in the side wall portions 223 located on the side where the first power storage stack 21 is located are arranged continuously in the second direction. The plurality of second unit cells 220 may be arranged in the second direction such that the second exhaust valves 226 are alternately positioned on one side in the first direction and the other side in the first direction.

The first unit cell 210 and the second unit cell 220 have a longitudinal shape in which the first direction is a longitudinal direction. The first unit cell 210 and the second unit cell 220 have a flat rectangular parallelepiped shape having a thickness in the second direction.

The first unit cell 210 and the second unit cell 220 include a housing 211, 221, and one or a plurality of electrode bodies 25 are accommodated in each housing 211, 221.

When a single electrode body 25 is accommodated, the electrode body 25 has a shape extending in the longitudinal direction. The electrode body 25 may be a laminated electrode body in which a negative electrode sheet, a separator, and a positive electrode sheet are laminated, or may be a wound electrode body in which a negative electrode sheet, a separator, and a positive electrode sheet are wound.

When the plurality of electrode bodies 25 are accommodated, the plurality of electrode bodies 25 are arranged side by side in the longitudinal direction and are connected in series. Also in this case, the electrode body 25 may be a laminated electrode body or a wound electrode body.

The first unit cell 210 and the second unit cell 220 are secondary batteries such as nickel metal hydride batteries or lithium-ion batteries. The first unit cell 210 and the second unit cell 220 may use a liquid electrolyte or a solid electrolyte. The first unit cell 210 and the second unit cell 220 may be chargeable and dischargeable capacitors.

Each housing 211, 221 is provided with a positive electrode external terminal 217 and a negative electrode external terminal 218. The positive electrode external terminal 217 and the negative electrode external terminal 218 are provided, for example, in an upper wall portion of the housing 211, 221.

The plurality of first unit cells 210 are arranged such that the positive electrode external terminals 217 and the negative electrode external terminals 218 are alternately arranged in the second direction. The plurality of first unit cells 210 are electrically connected in series by a bus bar module (not shown).

Similarly, the plurality of second unit cells 220 are arranged such that the positive electrode external terminals 217 and the negative electrode external terminals 218 are alternately arranged in the second direction. The plurality of second unit cells 220 are electrically connected in series by a bus bar module (not shown).

The power storage module 20 includes a total positive terminal 15 and a total negative terminal 16 of the total potential of the power storage module 20.

The total positive terminal 15 is constituted by the positive electrode external terminal 217 of the first unit cell 210 located at the most end in the second direction among the plurality of first unit cells 210. Specifically, the total positive terminal 15 is constituted by the positive electrode external terminal 217 of the first unit cell 210 located on the other side in the second direction.

The total negative terminal 16 is constituted by the negative electrode external terminal 218 of the second unit cell 220 located at the most end in the second direction among the plurality of second unit cells 220. Specifically, the total negative terminal 16 is constituted by the negative electrode external terminal 218 of the second unit cell 220 located on the most other side in the second direction.

The first connector 81 and the second connector 82 are provided in the housing case 30. Specifically, the first connector 81 and the second connector 82 are provided in the first wall portion 322 of the housing case 30 described later.

The first connector 81 is connected to the first connector 81 by a wire 83. The second connector 82 is connected to the second connector 82 by a wire 84. The wires 83 and 84 are arranged in the housing case 30.

The housing case 30 includes an upper member 31 and a lower member 32 as a lower case. The lower member 32 has a substantially box-shaped shape that opens upward. The lower member 32 includes a main body portion 35 and a fixed portion 36.

The main body portion 35 includes a bottom wall portion 321, a first wall portion 322, a second wall portion 323, and a pair of side wall portions 324, 325. The first wall portion 322, the second wall portion 323, and the pair of side wall portions 324, 325 are provided so as to stand up from the peripheral edge of the bottom wall portion 321. The first wall portion 322, the second wall portion 323, and the pair of side wall portions 324, 325 constitute a peripheral wall portion. The peripheral wall portion is connected to a peripheral edge portion of the bottom wall portion 321.

The first wall portion 322 and the second wall portion 323 face each other in the first direction. The first wall portion 322 is located on one side in the first direction. The second wall portion 323 is located on the other side in the first direction. The pair of side wall portions 324, 325 oppose each other in the second direction. The pair of side wall portions 324, 325 connect the first wall portion 322 and the second wall portion 323. The side wall portion 324 connects end portions of the first wall portion 322 and the second wall portion 323 located on one side in the second direction. The side wall portion 325 connects end portions of the first wall portion 322 and the second wall portion 323 located on the other side in the second direction.

The fixed portion 36 is provided on an outer surface of the pair of side wall portions 324, 325. The fixed portion 36 is provided so as to extend intermittently in the first direction. A portion of the fixed portion 36 located on the most one side in the first direction is longer in length in the first direction than the other portions.

The upper member 31 has a substantially plate-like shape. The upper member 31 closes the opening of the lower member 32. The shape of the upper member is not limited to a plate shape, and may be a substantially box shape that opens downward. The upper member 31 has a top plate portion facing the bottom wall portion 321 in the up-down direction.

The cross member 40 is disposed between the first power storage stack 21 and the second power storage stack 22 in the housing case 30. The cross member 40 extends along a direction intersecting the arrangement direction in which the first power storage stack 21 and the second power storage stack 22 are arranged. Specifically, the cross member 40 extends along the second direction orthogonal to the arrangement direction (first direction). A gap is formed between the cross member 40 and the upper member 31.

The cross member 40 is fixed to the lower member 32. The cross member 40 is made of, for example, a metallic member such as SUS. The cross member 40 partitions an area in the lower member 32. Specifically, the cross member 40 divides the region in the lower member 32 into two in the first direction. The first power storage stack 21 is disposed in one of the two partitioned regions, and the second power storage stack 22 is disposed in the other of the two regions.

The housing case 30 has an expansible region 311 that is inflatable when gas is discharged from the first power storage stack 21 or the second power storage stack 22. The expansible region 311 faces the cross member 40 in a direction intersecting the arrangement direction. The expansible region 311 is deformably provided, for example, so as to bulge away from the cross member 40 when the gas is exhausted.

The expansible region 311 faces in a direction orthogonal to the arrangement direction and the extending direction of the cross member 40. That is, the expansible region 311 faces the cross member 40 in the up-down direction, and the expansible region 311 is provided in the top plate portion of the housing case 30. The expansible region 311 has a lower rigidity than a portion of the housing case 30 located around the expansible region 311. The expansible region 311 may be formed to be thinner than a portion located around the expansible region 311, for example. Note that the expansible region 311 may be provided in a part of the top plate portion or may be provided entirely in the top plate portion.

The electrical connection member 50 electrically connects the first power storage stack 21 and the second power storage stack 22. The electrical connection member 50 is constituted by, for example, a conductive member such as a bus bar. The electrical connection member 50 is disposed so as to straddle the cross member 40. Thus, interference between the electrical connection member 50 and the cross member 40 can be suppressed. In addition, it is possible to prevent the electrical connection member 50 and the cross member 40 from being short-circuited.

The electrical connection member 50 electrically connects the negative electrode external terminal 218 of the first power storage stack 21 and the positive electrode external terminal 217 of the second power storage stack 22. More specifically, the electrical connection member 50 electrically connects the negative electrode external terminal 218 of the first unit cell 210 and the positive electrode external terminal 217 of the second unit cell 220. The negative electrode external terminal 218 is located on the most one side of the plurality of first unit cells 210 in the second direction. The positive electrode external terminal 217 is located on the most one side in the second direction among the plurality of second unit cells 220.

The electrical connection member 50 has fragile portions 53c, 54c and is secured to the expansible region 311.

The electrical connection member 50 has a substantially U-shape. The electrical connection member 50 includes a first connection piece portion 51, a second connection piece portion 52, a first rising portion 53, a second rising portion 54, and a third connection piece portion 55.

The first connection piece portion 51 is connected to the negative electrode external terminal 218 of the first power storage stack 21. The second connection piece portion 52 is connected to the positive electrode external terminal 217 of the second power storage stack 22. The first connection piece portion 51 and the second connection piece portion 52 have a substantially plate-like shape. The first connection piece portion 51 and the second connection piece portion 52 are spaced apart from each other in the first direction. The first connection piece portion 51 is located on one side in the first direction, and the second connection piece portion 52 is located on the other side in the first direction.

The first rising portion 53 is provided so as to rise from an end portion of the first connection piece portion 51 located on a side close to the second connection piece portion 52 in the first direction. The second rising portion 54 is provided so as to rise from the end portion of the second connection piece portion 52 located on the side close to the first connection piece portion 51 in the first direction.

Each of the first rising portion 53 and the second rising portion 54 is provided with a fragile portion 53c, 54c formed by being provided with a notched portion, a thin portion, or the like.

The fragile portion may be provided in at least one of the first rising portion 53 and the second rising portion 54. As will be described later, as long as the electrical connection member 50 is broken along with the deformation of the expansible region 311, the fragile portion may be provided in at least one of the first connection piece portion 51, the second connection piece portion 52, and the third connection piece portion 55.

The third connection piece portion 55 connects the first rising portion 53 and the second rising portion 54. The third connection piece portion 55 has a substantially plate-like shape. The third connection piece portion 55 is fixed to the expansible region 311 by being fixed to the insulating member 60 fixed to the expansible region 311. The insulating member 60 is fixed to the expansible region 311 by welding or the like. The third connection piece portion 55 is fixed to the insulating member 60 by welding or the like.

In this manner, the electrical connection member 50 is fixed to the expansible region 311 with the insulating member 60 interposed therebetween with respect to the expansible region 311. The insulating member 60 has, for example, a plate-like shape. The insulating member 60 insulates the electrical connection member 50 from the housing case 30 (more specifically, the upper member 31).

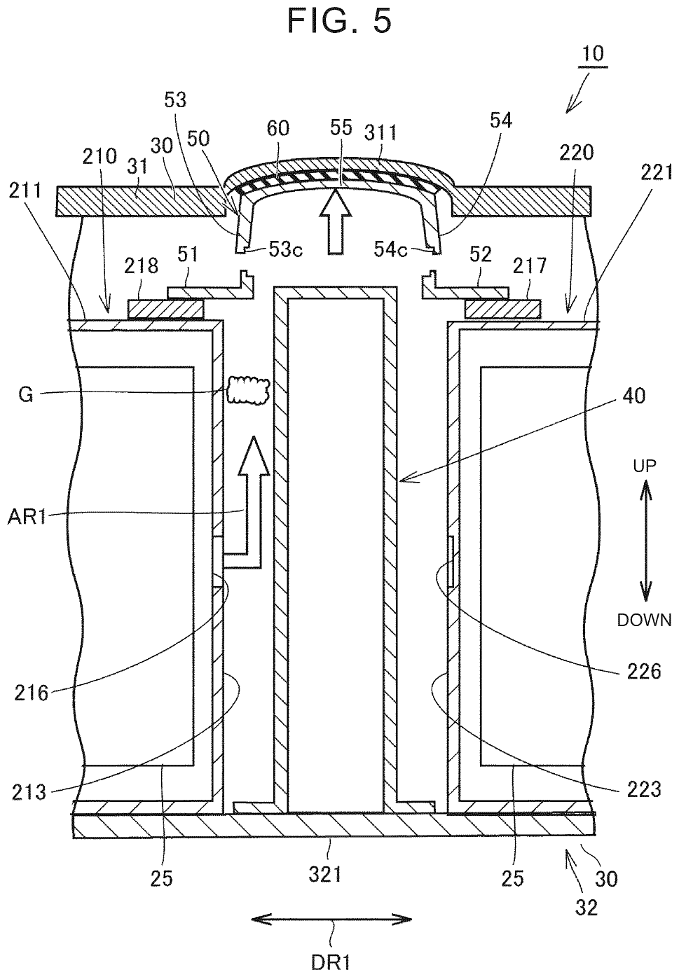

FIG. 5 is a schematic cross-sectional view illustrating a state in which gas is discharged from the first power storage stack in the power storage device according to the first embodiment. Note that the state around the expansible region 311 when the gas is discharged from the second power storage stack 22 is substantially the same as the state when the gas is discharged from the first power storage stack 21, and thus the description thereof will be omitted here.

As illustrated in FIG. 5, when the gas G is discharged from the first power storage stack 21, that is, at least one of the plurality of first unit cells 210 included in the first power storage stack 21 generates heat. When the gas G is discharged from the first exhaust valve 216, at least a portion of the gas G is also diffused into the space in the housing case 30. As a result, the pressure in the housing case 30 increases, and the expansible region 311 is deformed so as to bulge toward the outside of the housing case 30.

With the deformation of the expansible region 311, the electrical connection member 50 (more specifically, the third connection piece portion 55) fixed to the expansible region 311 is pulled in a direction away from the positive electrode external terminal 217 and the negative electrode external terminal 218. At this time, the fragile portion 53c, 54c is broken. Thus, the electrical connection between the first power storage stack 21 and the second power storage stack 22 can be interrupted.

In general, when gas is discharged from the power storage stack in the housing case 30, debris such as metal foreign matters is also discharged into the housing case 30. When the debris adheres to the wire 83 and the wire 84 so as to straddle the wire 83 and the wire 84, the total positive terminal 15 and the total negative terminal 16 are electrically connected, and these are short-circuited. In such a case, the power storage module 20, that is, the first power storage stack 21 and the second power storage stack 22 generate heat as a whole.

Here, in the present embodiment, as described above, the expansible region 311 expands and the fragile portion 53c, 54c breaks, so that the first power storage stack 21 and the second power storage stack 22 are electrically disconnected from each other. As a result, even when the total positive terminal 15 and the total negative terminal 16 are short- circuited, it is possible to prevent the first power storage stack 21 and the second power storage stack 22 from generating heat as a whole.

Further, since the cross member 40 is disposed between the first power storage stack 21 and the second power storage stack 22, the traveling direction of the gases G discharged from the first power storage stack 21 by the cross member 40 is changed as indicated by the arrow AR1. Since the expansible region 311 is disposed opposite to the cross member 40, the gas G is easily moved toward the expansible region 311. As a result, the fragile portion 53c, 54c is easily broken when the gases G are generated. Further, since the electrical connection member 50 is provided so as to straddle the cross member 40, the fragile portion 53c, 54c can be broken by using the force of the gas G whose traveling direction is changed.

### Embodiment 2

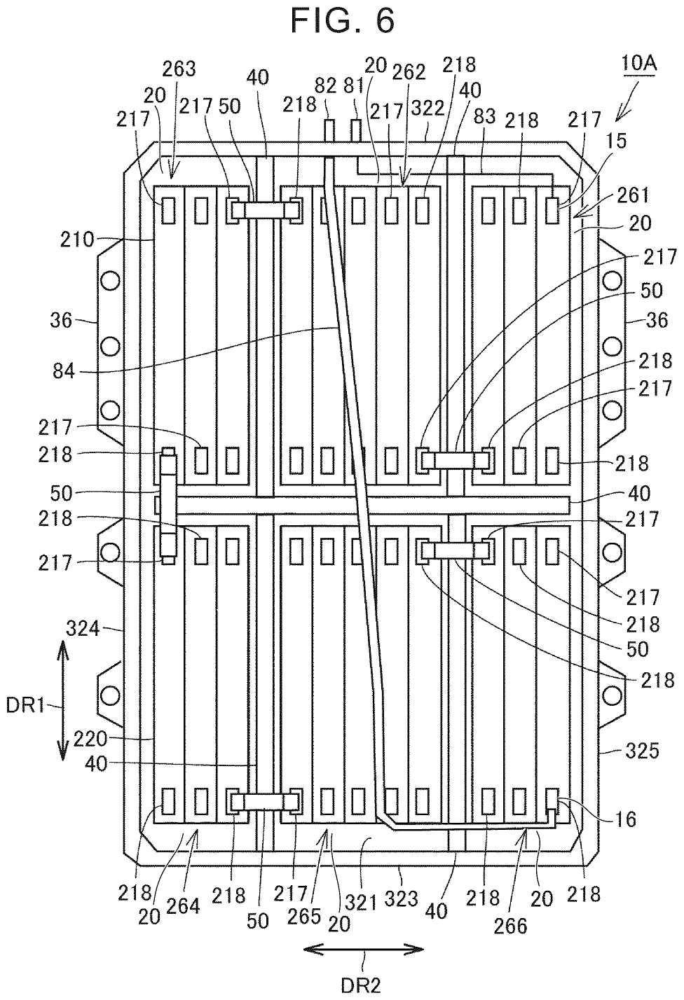

FIG. 6 is a plan view illustrating an internal configuration of a power storage device according to Embodiment 2. Referring to FIG. 6, a power storage device 10A according to a second embodiment will be described.

As shown in FIG. 6, in the power storage device 10A according to the second embodiment, the number and arrangement of the plurality of power storage stacks 261 to 266 are different from those of the power storage device 10 according to the first embodiment, and thus the arrangement of the plurality of cross members 40 is mainly different. Other configurations are substantially the same.

The plurality of power storage stacks 261 to 266 constituting the power storage module 20 are arranged in a matrix. The plurality of power storage stacks 261 to 266 are arranged in three rows and two columns when the first direction is a column direction and the second direction is a row direction.

The plurality of cross members 40 are arranged in a grid pattern to define regions for arranging the respective power storage stacks 261 to 266. The cross member 40 (first cross member) extending along the second direction at a substantially central portion in the first direction is partitioned into two regions in the first direction. Each of the two regions is divided into three by two cross members 40 (second cross members) spaced apart in the second direction. Each power storage stack is arranged in each divided region.

Also in this case, the power storage stacks (the first power storage stack and the second power storage stack) adjacent to each other in the second direction are electrically connected by the electrical connection member 50. The power storage stacks 263, 264 adjacent to each other in the first direction are also electrically connected by the electrical connection member 50. The electrical connection member 50 has the same configuration as that of the first embodiment, and is fixed to an expansible region (not shown in FIG. 6) of the housing case 30.

Even with the configuration as described above, the power storage device 10A according to the second embodiment has substantially the same advantages as those of the first embodiment.

### Other Variations

In Embodiments 1 and 2 described above, the case where the positive electrode external terminal 217 and the negative electrode external terminal 218 are provided in the upper wall portion of the housing 211, 221 has been described as an example. However, the present disclosure is not limited thereto, and may be provided on the side wall portion of the housing 211, 221 in the first direction.

Further, in Embodiments 1 and 2 described above, the case where the expansible region 311 is provided in the top plate portion of the housing case 30 has been exemplified, but the present disclosure is not limited thereto. The expansible region 311 may be provided in one of the pair of side wall portions 324, 325 or the bottom wall portion 321 of the housing case 30 so long as the electrical connection member 50 fixed to the expansible region 311 is broken in accordance with the expansion deformation.

In Embodiments 1 and 2 described above, the case where the number of power storage stacks is two or six has been described as an example, but the present disclosure is not limited thereto. The number of the power storage stacks can be appropriately set as long as the first power storage stack and the second power storage stack are connected by the electrical connection member 50.

The embodiments disclosed herein are illustrative and not restrictive in all respects. The scope of the present disclosure is defined by the claims, and includes all modifications within the meaning and range equivalent to the claims.

What is claimed is:

1. A power storage device comprising:
a first power storage stack and a second power storage stack;
a housing case that houses the first power storage stack and the second power storage stack; and
an electrical connection member that electrically connects the first power storage stack and the second power storage stack, wherein
the housing case includes an expansible region that is expansively deformable when gas is discharged from the first power storage stack or the second power storage stack, and
the electrical connection member includes a fragile portion that is breakable, and is fixed to the expansible region.

2. The power storage device according to claim 1, wherein an insulating member is interposed between the electrical connection member and the expansible region.

3. The power storage device according to claim 1, further comprising a cross member that is disposed between the first power storage stack and the second power storage stack in the housing case and extends along a direction intersecting an arrangement direction in which the first power storage stack and the second power storage stack are arranged, wherein
the expansible region is disposed to face the cross member in a direction intersecting the arrangement direction, and
the electrical connection member is provided to straddle the cross member.

4. The power storage device according to claim 3, wherein:
the housing case includes a top plate portion; and
the expansible region is provided to the top plate portion.
